(19) United States
(12) Patent Application Publication
(10) Pub. No.: US 2004/0249770 A1
(43) Pub. Date: Dec. 9, 2004

(54) Cost computing system and method

(76) Inventors: Pu-Yang Yeh, Tu-Chen (TW); Ping Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/861,721

(22) Filed: Jun. 3, 2004

(30) Foreign Application Priority Data
Jun. 3, 2003 (TW) 92115115

(51) Int. Cl. G06F 17/60

(52) U.S. Cl. 705/400; 705/1

(57) ABSTRACT

A cost computing system includes a plurality of client computers (10), an application server (12), and a database (14). The cost computing system is connected to a manufacturing system (15) and a supplier goods providing system (16). Each client computer provides a user interface for inputting and obtaining information from the application server. The application server is for computing item costs, and includes a basic information maintaining module (21), a BOM (bill of material) copying module (22), an outsourcing item cost posting module (23), a standard BOM cost computing module (24), an item cost collecting module (25) and a statement generating module (26). The database is for storing all data used and generated by the system. A related cost computing method is also provided.

### BACKGROUND OF THE INVENTION

1. Field of the Invention

The present invention relates to cost computing systems and methods, and particularly to a cost computing system and method that can respectively compute and display various kinds of costs, the kinds of costs being material costs, manufacturing costs and supplementary costs.

2. Background of the Invention

Cost computation is vital for large-scale businesses such as manufacturing corporations. The traditional industry method is to compute costs of each month through work centers; that is, accountants carry forward costs of manufacturing steps to work centers, and compute total costs step by step. This method is usually done manually or electronically with Microsoft Excel files. In either case, the procedures require considerable manpower, and are prone to human error. Accountants often compute and update costs information only every two or three months. Furthermore, the method is problematic when costs are computed according to kinds of costs and cost structures. Accordingly, many modern manufacturing corporations have adopted computer and network technology to bring cost computation into the realm of e-business. The use of an electronic cost account computation system greatly improves efficiency in computing costs.

Cost computing systems and methods are disclosed in a number of patents. U.S. Pat. No. 6,356,880 issued on Mar. 12, 2002 and entitled “Methods And Systems For Dynamic Cost Allocation Through Task Auto Assignment” discloses methods and systems for automatically assigning tasks to interrelated tasks according to a regulation. The methods and systems can obtain details of cost computation without limiting data sources of interrelated costs, and the methods and systems concentrate on cost assignments. However, the methods and systems do not provide for respectively computing and displaying various kinds of costs.

### SUMMARY OF THE INVENTION

Accordingly, a main objective of the present invention is to provide a cost computing system and method which can respectively compute and display various kinds of costs, the kinds of costs being material costs, manufacturing costs and supplementary costs.

To accomplish the above objective, a cost computing system in accordance with a preferred embodiment of the present invention includes a plurality of client computers, an application server and a database. The cost computing system is connected to a manufacturing system and a supplier goods providing system. Each client computer provides a user interface for inputting and obtaining information. The application server includes: a basic information maintaining module for maintaining all kinds of basic information; a bill of material (BOM) copying module for copying general BOM information to standard BOM cost information; an outsourcing item cost posting module for automatically posting basic information on outsourcing items to corresponding columns of a standard format BOM cost information table; a standard BOM cost computing module for computing standard BOM costs of items according to components and their cost levels; an item cost collecting module for collecting and respectively displaying item costs, which include material costs, manufacturing costs and supplementary costs; and a statement generating module for generating statements according to conditions set by users. The client computers are connected to the application server through an electronic communication network. The application server is connected to the database through a database connectivity.

Further, the present invention provides a preferred cost computing method comprising the steps of: (a) maintaining basic information through a user interface; (b) determining an item's attribute, and inputting an identifying code and posting basic information on the outsourcing item to corresponding columns of a standard format BOM cost information table if the item is an outsourcing item, or inputting a manufacturing code and automatically copying general BOM information to a standard format BOM cost information table if the item is a self-manufacturing item; (c) computing standard BOM costs; (d) collecting and respectively displaying item costs; which include a material cost or a manufacturing cost, and a supplementary cost; and (e) generating statements.

Other objects, advantages and novel features of the present invention will be drawn from the following detailed description with reference to the attached drawings, in which:

### BRIEF DESCRIPTION OF THE DRAWINGS

FIG. 1 shows relationships between various kinds of costs defined by a manufacturing enterprise in accordance with the preferred embodiment of the present invention;

FIG. 2 is a schematic diagram of hardware infrastructure of a cost computing system in accordance with the preferred embodiment of the present invention;

FIG. 3 is a schematic diagram of main function modules of an application server of the cost computing system of FIG. 2;

FIG. 4 is a flowchart of the preferred method for implementing the cost computing system of the present invention; and

FIG. 5 is a flowchart of a preferred method for carrying out one of the steps of FIG. 4, namely computing a standard BOM cost of an item

### DETAILED DESCRIPTION OF THE INVENTION

In the following description relating to a manufacturing enterprise, a “self-manufacturing item” is one that is processed or used by the manufacturing enterprise without any need for outsourcing. Once processed or used, the item or an assembly incorporating the item is sold to a customer. An “outsourcing item” is one that is provided to the manufacturing enterprise by an outsourcing company. Typically, the outsourcing company procures raw materials from a supplier, processes the raw materials, and sells the processed materials to the manufacturing enterprise. The manufacturing enterprise then further processes or uses said processed materials.

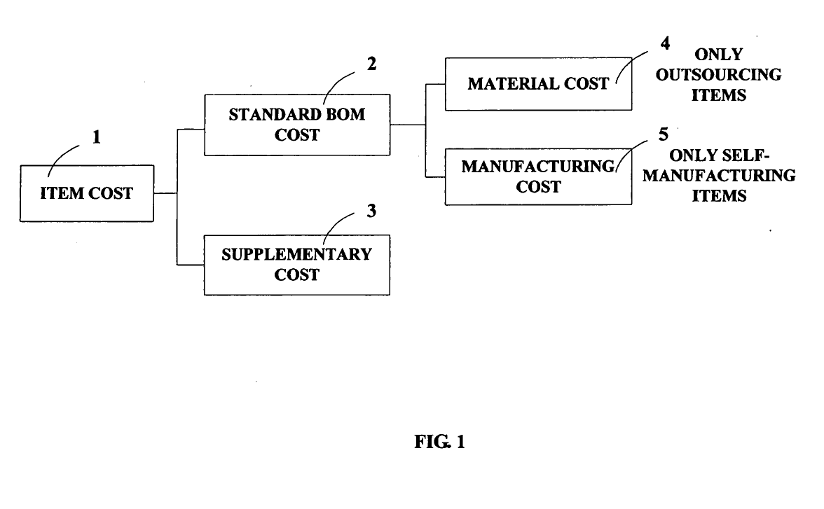

FIG. 1 shows relationships between various kinds of costs defined by the manufacturing enterprise in accordance with the preferred embodiment of the present invention. These costs are item cost 1, standard BOM cost 2, supplementary cost 3, material cost 4, and manufacturing cost 5. Item cost 1 comprises standard BOM cost 2 and supplementary cost 3. Standard BOM cost 3 comprises material cost 4 or manufacturing cost 5. In this description, material cost 4 means the total cost of an item sold to the manufacturing enterprise by an outsourcing company. Such total cost includes the cost of the original raw material procured by the outsourcing company, plus the outsourcing company's charge for processing the raw material. In this description, manufacturing cost 5 means the cost incurred by the manufacturing enterprise in processing a self-manufacturing item, and does not include the cost of procuring the self-manufacturing item from the supplier of the self-manufacturing item. Accordingly, an outsourcing item comprises a material cost 4 but does not comprise a manufacturing cost 5. Conversely, a self-manufacturing item comprises a manufacturing cost 5 but does not comprise a material cost 4. Supplementary cost 3 is the sum of other costs of an item apart from the material cost 4 or the manufacturing cost 5.

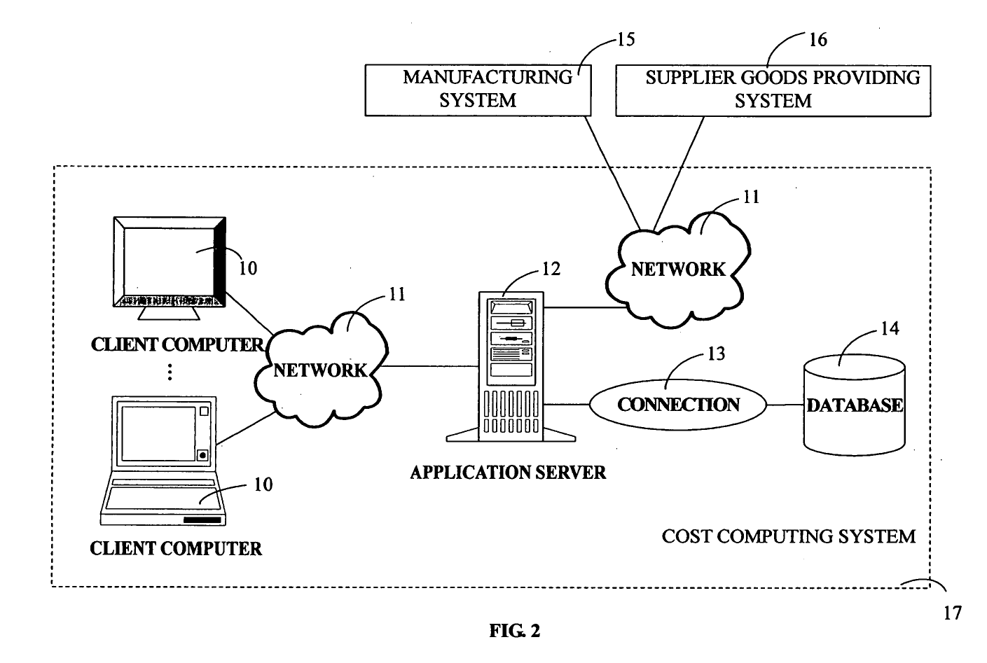

FIG. 2 is a schematic diagram of hardware infrastructure of a cost computing system 17 in accordance with the preferred embodiment of the present invention. The cost computing system 17 is employed by the manufacturing enterprise, and comprises a plurality of client computers 10, an application server 12 and a database 14. The cost computing system 17 is connected to a manufacturing system 15 and a supplier goods providing system 16 through an electronic communication network 11. The network 11 may be any suitable communication architecture required by the cost computing system 17, such as a local area network or a wide area network. The manufacturing system 15 provides general bill of material (BOM) information for items. Each item is either a self-manufacturing item or an outsourcing item. A self-manufacturing item may be work-in-process, a semifinished product, or a finished product. Similarly, an outsourcing item may be work-in-process, a semifinished product, or a finished product. The general BOM information comprises numbers, names, quantities, wastage rates and attributes of all low level items used in a high lever item. In the preferred embodiment of the present invention, each item's attribute is either self-manufacturing or outsourcing. The supplier goods providing system 16 is employed by the manufacturing enterprise for providing information on outsourcing items, such information including numbers, names, prices and quantities of outsourcing items.

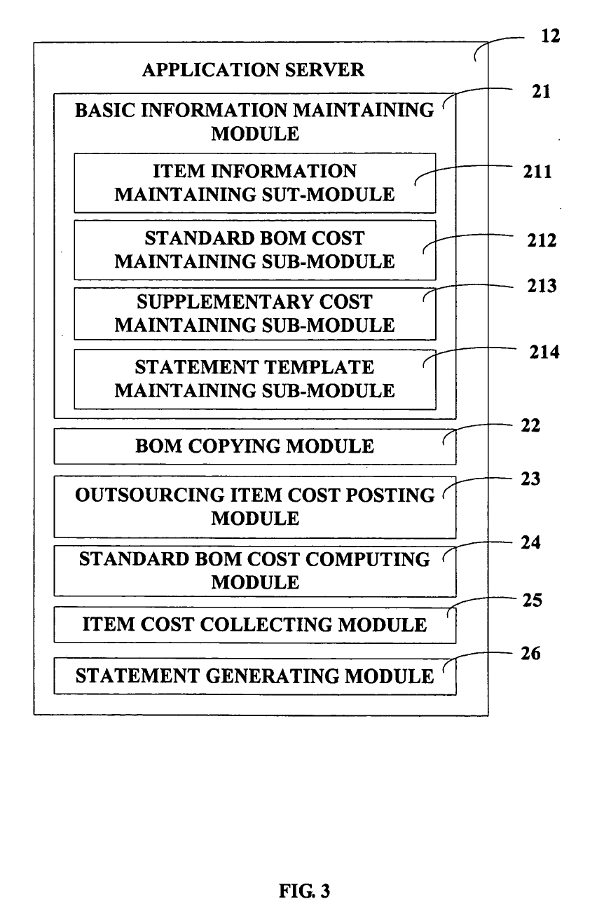

The client computers 10 are connected to the application server 12 through the network 11. The application server 12 is connected to the database 14 through a connection 13. The connection 13 is a database connectivity, such as an ODBC (Open Database Connectivity) or a JDBC (Java Database Connectivity). Each of the client computers 10 provides a user interface for users to maintain information. The application server 12 comprises a plurality of function modules, which are described in detail below in relation to FIG. 3. The database 14 stores all kinds of data used and generated in the above-described processes.

FIG. 3 is a schematic diagram of main function modules of the application server 12. The application server 12 comprises a basic information maintaining module 21, a BOM copying module 22, an outsourcing item cost posting module 23, a standard BOM cost computing module 24, an item cost collecting module 25, and a statement generating module 26.

The basic information maintaining module 21 maintains all kinds of basic information, including by way of adding, modifying, searching, deleting, coping and printing basic information. The basic information includes item information, standard BOM costs, supplementary costs and statement templates, all of which are stored in the database 14. The basic information maintaining module 21 comprises an item information maintaining sub-module 211, a standard BOM cost maintaining sub-module 212, a supplementary cost maintaining sub-module 213, and a statement template maintaining sub-module 214. The item information maintaining sub-module 211 maintains item information. Such item information includes numbers, names, units, specifications, source codes, identifying codes, manufacturing codes, and so on. A source code indicates an item's attribute according to a predetermined symbol; for example, P represents an outsourcing item and M represents a self-manufacturing item. An identifying code or manufacturing code is determined by an item's source code, and indicates the item's further attribute. The item's further attribute is used for management purposes, or for limiting the item's cost in computing procedures. When a source code indicates an outsourcing item, the outsourcing item is further marked with an identifying code. For example, ten different basic components of the item are represented by the numbers 1 through 10. If the identifying code is 6, this indicates one particular component of the item. When a source code indicates a self-manufacturing item, the self-manufacturing item is further marked with a manufacturing code. For example, six different processing schedules for the item are represented by the numbers 1 through 6. If the manufacturing code is 2, this indicates one particular processing schedule for the item. The processing schedules are procedures for manufacturing an item, such as stamping, molding and painting. The standard BOM cost maintaining sub-module 212 sets and maintains standard BOM cost information. The standard BOM cost information comprises a component structure and standard times. A standard time is the time normally taken to process a particular self-manufacturing item, and each standard time is typically determined by a production management department of the manufacturing enterprise. Columns of the standard BOM cost information include edition, number, name, source code, identifying code or manufacturing code, component, standard QPA, labor cost apportioned per hour, manufacturing cost apportioned per hour, standard time, unit cost, material cost, supplementary cost, and so on. The edition relates to a requested year and month, because fluctuations in standard BOM costs can occur yearly or even monthly. The standard QPA is a standard quantity of each component used in an item. The unit cost for each item is calculated using different computing methods, depending on the item's attribute. That is, the unit cost of an outsourcing item is the purchasing unit price, and the unit cost of a self-manufacturing item is the sum of labor costs apportioned per hour and manufacturing costs apportioned per hour. The supplementary cost maintaining sub-module 213 maintains supplementary costs. The statement template maintaining sub-module 214 maintains types, layouts and formats of statements. The statement types comprise a supplementary cost searching statement, an item cost searching statement, a detailed cost searching statement, and a comparison table.

The BOM copying module 22 obtains general BOM information on a self-manufacturing item from the manufacturing system 15 according to a predetermined standard (such as a beginning number or an ending number), and automatically copies the general BOM information to a standard format BOM cost information table according to predetermined columns. The columns are maintained by the standard BOM cost maintaining sub-module 212. The copied standard format BOM cost information table is stored in the database 14.

The outsourcing item cost posting module 23 obtains information on an outsourcing item from the supplier goods providing system 16, and posts the information to corresponding columns of a standard format BOM cost information table. The columns are maintained by the standard BOM cost maintaining sub-module 212. The standard format BOM cost information table is stored in the database 14.

The standard BOM cost computing module 24 computes standard BOM costs of items. This is done by way of calculating step by step from low level components to high level components, or from high level components to low level components. The components and their levels are maintained by the standard BOM cost maintaining sub-module 212. The result of each level is stored in the database 14. With this framework, the standard BOM cost computing module 24 can easily compute the standard BOM cost of each item no matter what level it belongs to, according to a predetermined standard. The predetermined standard can be a beginning number, an ending number, one specified number, more than one specified number, and so on. A standard BOM cost of each requested item is stored in the database 14.

The item cost collecting module 25 obtains supplementary cost information on a requested item from the supplementary cost maintaining sub-module 213, adds the supplementary cost to the standard BOM cost of the item, and thereby obtains a resulting item cost. The item cost is displayed with its applicable component supplementary cost, material cost and manufacturing cost. The item cost is stored in the database 14.

The statement generating module 26 obtains results and corresponding statement templates according to parameters set by users, in order to generate requested statements. The parameters include item number, cost, identifying code or manufacturing code, and so on.

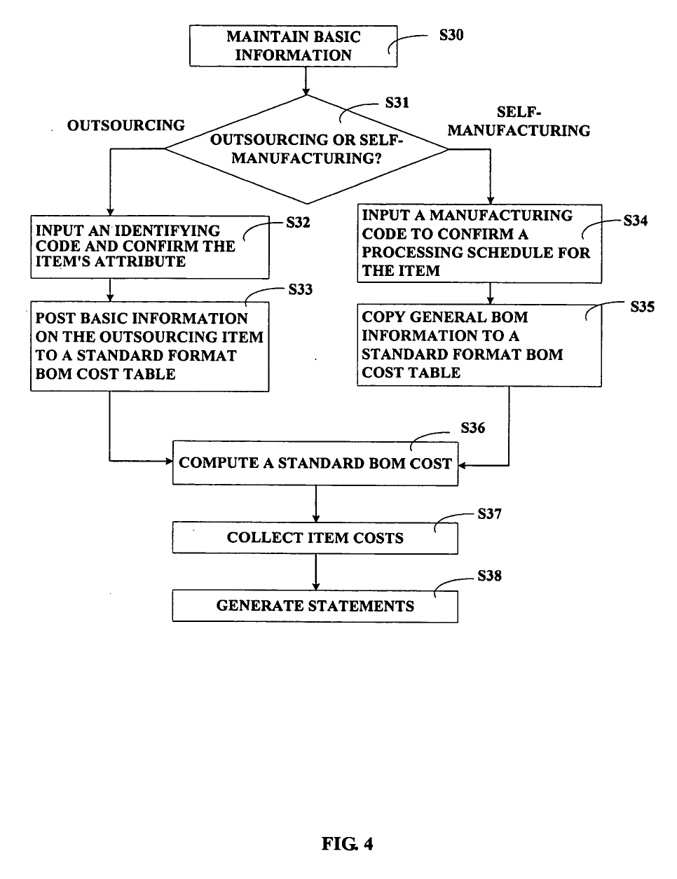

FIG. 4 is a flowchart of a preferred method for implementing the cost computing system of the present invention. In step S30, the basic information maintaining module 21 sets and maintains basic information. The basic information is stored in the database 14, and can be searched by any user from any client computer 10. In step S31, the basic information maintaining module 21 determines whether an item is an outsourcing item or a self-manufacturing item. If the item is an outsourcing item, in step S32, an identifying code is input to further confirm the item's attribute. Then in step S33, the outsourcing item cost posting module 23 obtains basic information on the outsourcing item from the supplier goods providing system 16 according to a predetermined standard, and automatically posts the information to corresponding columns of a standard format BOM cost information table. The standard format BOM cost information table is stored in the database 14. Thereupon the procedure goes to step S36 described below.

If the item is a self-manufacturing item, in step S34, a manufacturing code is input to confirm a processing schedule for the item. Then in step S35, the BOM copying module 22 obtains general BOM information on the self-manufacturing item from the manufacturing system 15, and automatically copies the general BOM information to a standard format BOM cost information table according to predetermined columns. The columns are maintained by the standard BOM cost maintaining sub-module 212. The copied standard format BOM cost information table is stored in the database 14. Thereupon the procedure goes to step S36 described below.

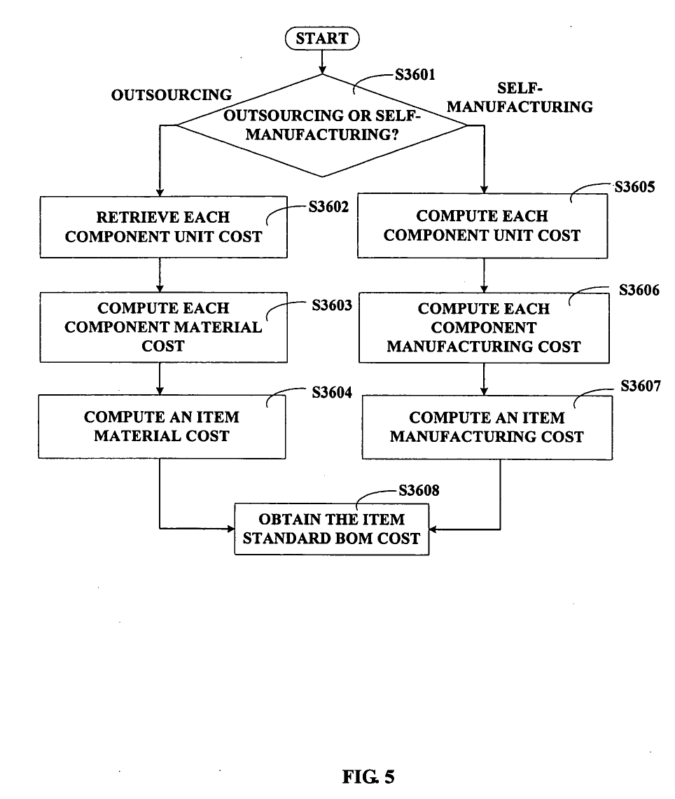

In step S36, the standard BOM cost computing module 23 computes the standard BOM cost of the item. This procedure is explained in detail below in relation to FIG. 5. In step S37, the item cost collecting module 25 collects and displays the item's costs, which include the applicable material cost or manufacturing cost, and the item's supplementary cost. In step S38, the statement generating module 28 generates statements. The statements are displayed to a user through a user interface, and can be printed and saved.

FIG. 5 is a flowchart of the preferred method for carrying out step S36 of FIG. 4, namely computing a standard BOM cost of an item. In step S3601, the basic information maintaining module 21 determines whether an item is an outsourcing item or a self-manufacturing item. If the item is an outsourcing item, in step S3602, the standard BOM cost computing module 24 reads each component unit price and standard QPA from the standard BOM cost maintaining sub-module 212. In step S3603, the standard BOM cost computing module 24 multiplies each component unit price and standard QPA to obtain a material cost of each component of the item. In step S3604, the standard BOM cost computing module 24 computes a material cost of the item by way of collecting the material cost of each component from low levels to high levels. The material cost is stored in the database 14.

If the item is a self-manufacturing item, in step S3605, the standard BOM cost computing module 24 reads each component unit price, standard QPA and standard time from the standard BOM cost maintaining sub-module 212. In step S3606, the standard BOM cost computing module 24 multiplies each component unit price, standard QPA and standard time to obtain a manufacturing cost of each component of the item. In step S3607, the standard BOM cost computing module 24 computes a manufacturing cost of the item by way of collecting the manufacturing cost of each component from low levels to high levels. The manufacturing cost is stored in the database 14.

For an outsourcing item, a material cost is the item standard BOM cost; for a self-manufacturing item, a manufacturing cost is the item standard BOM cost. Accordingly, in step S3608, the item standard BOM cost is obtained according to the above definitions.

Although the present invention has been specifically described on the basis of a preferred embodiment and preferred methods, the invention is not to be construed as being limited thereto. Various changes and modifications may be made to the embodiment and method without departing from the scope and spirit of the invention.

What is claimed is:

1. A cost computing system comprising:
one or more client computers, each of said client computers providing a user interface for inputting and displaying data;
a database for storing data; and
an application server for automatically computing item costs, said application server comprising:
a basic information maintaining module for maintaining various kinds of basic information;
a BOM (bill of material) copying module for obtaining general BOM information on self-manufacturing items, and automatically copying the general BOM information on self-manufacturing items to a standard format BOM cost information table according to predetermined columns;
an outsourcing item cost posting module for obtaining information on outsourcing items, and posting the information on outsourcing items to corresponding columns of a standard format BOM cost information table;
a standard BOM cost computing module for computing standard BOM costs of items; and
an item cost collecting module for collecting and displaying item costs.

2. The cost computing system according to claim 1, wherein the basic information maintaining module comprises:
an item information maintaining sub-module for maintaining item information;
a standard BOM cost maintaining sub-module for setting and maintaining standard BOM cost information;
a supplementary cost maintaining sub-module for maintaining supplementary costs; and
a statement template maintaining sub-module for maintaining statement types, layouts and formats.

3. The cost computing system according to claim 1, wherein the item costs comprise material costs, manufacturing costs and supplementary costs.

4. A computer-enabled cost computing method, comprising the steps of:
maintaining basic information;
determining whether an item is an outsourcing item or a self-manufacturing item;
inputting an identifying code and automatically posting outsourcing standard BOM (bill of material) costs if the item is an outsourcing item; or
inputting a manufacturing code and copying general BOM information to a standard BOM cost information document if the item is a self-manufacturing item;
computing a standard BOM cost of the item; and
collecting the item costs.

5. The cost computing method according to claim 4, wherein the step of computing a standard BOM cost of the item comprises the steps of:
reading each component unit price and standard QPA;
multiplying each component unit price and standard QPA to obtain a material cost of each component of the item; and
computing a material cost of the item by way of collecting the material cost of each component from low levels to high levels if the item is an outsourcing item;
wherein a standard QPA is a standard quantity of each component used in the item.

6. The cost computing method according to claim 4, wherein the step of computing a standard BOM cost of the item comprises the steps of:
reading each component unit price, standard QPA and standard time;
multiplying each component unit price, standard QPA and standard time to obtain a manufacturing cost of each component of the item; and
computing a manufacturing cost of the item by way of collecting the manufacturing cost of each component from low levels to high levels if the item is a self-manufacturing item;
wherein a standard QPA is a standard quantity of each component used in the item.

7. The cost computing method according to claim 4, wherein the item costs comprise a material cost or a manufacturing cost, and a supplementary cost.

8. The cost computing method according to claim 4, further comprising the step of automatically generating one or more corresponding statements according to terms set by one or more users.
